(19) United States
(12) Patent Application Publication
(10) Pub. No.: US 2022/0032690 A1
(43) Pub. Date: Feb. 3, 2022

(54) MOTORCYCLE TIRE

(71) Applicant: Sumitomo Rubber Industries, Ltd., Kobe-shi (JP)

(72) Inventor: Shuji KOBORI, Kobe-shi (JP)

(73) Assignee: Sumitomo Rubber Industries, Ltd., Kobe-shi (JP)

(21) Appl. No.: 17/375,152

(22) Filed: Jul. 14, 2021

(30) Foreign Application Priority Data
Jul. 29, 2020 (JP) 2020-127922

(51) Int. Cl. B60C 11/00; B60C 9/18

(52) U.S. Cl. CPC B60C 11/0008; B60C 11/005; B60C 2011/0025; B60C 2200/10; B60C 2011/0033; B60C 9/18

(57) ABSTRACT

A motorcycle tire includes a tread portion, a carcass, a breaker layer disposed outside the carcass with cords oriented at an angle equal to or more than 15 degrees with respect to a tire equator, and a tread rubber disposed outside the breaker layer so as to form a band-less structure in which the tread rubber is arranged so as to be directly in contact with the breaker layer. The tread rubber includes a cap rubber layer forming a ground contacting surface of the tread portion, and a base rubber layer disposed inside the cap rubber layer and having complex modulus greater than that of the cap rubber layer. The base rubber layer extends between a pair of outermost ends thereof so as to across the tire equator, and a thickness of the base rubber layer at the tire equator is greater than that of the outermost ends.

### BACKGROUND ART

### Field of the Disclosure

The present disclosure relates to a motorcycle tire.

### Description of the Related Art

The following Patent document 1 discloses a pneumatic tire for two-wheeled vehicle which includes a belt layer and a tread rubber disposed outwardly of the belt layer in the tire radial direction. The belt layer includes a spiral belt layer having a cord oriented at an angle of from 0 to 5 degrees with respect to the tire equator and a crossed belt layer having cords oriented at an angle of 50 degrees. The tread rubber includes a surface layer, and a dissimilar rubber layer disposed inside the surface layer in the tire radial direction.

### PATENT DOCUMENT

### [Patent Document 1]

Japanese Unexamined Patent Application Publication 2009-96426

### SUMMARY OF THE DISCLOSURE

The spiral belt layer as described above is effective in improving stability at high-speed driving, but has a problem of excessively increasing the rigidity of the tread portion, which may deteriorate ride comfort performance of the tire.

From this point of view, a pneumatic tire for two-wheeled vehicle having a so-called band-less structure, in which the belt layer is provided with only the crossed belt layer, has also been proposed. However, when the tire is being vulcanized, the vicinity of the tire equator of the crossed belt layer expands outwardly in the tire radial direction more than the vicinity of the tread shoulders. Thus, the cord spacing of the crossed belt layer becomes large, and rigidity of the crossed belt layer tends to be small. For this reason, such a pneumatic tire for motorcycles with a band-less structure may have reduced steering stability.

The present disclosure has been made in view of the above circumstances and has a major object to provide a motorcycle tire capable of improving steering stability while maintaining ride comfort.

In one aspect of the disclosure, a motorcycle tire includes a tread portion having a ground contacting surface, a carcass, a breaker layer disposed outwardly in a tire radial direction of the carcass in the tread portion, the breaker layer including one or more breaker plies having a plurality of cords oriented at an angle equal to or more than 15 degrees with respect to a tire equator, and a tread rubber disposed outwardly in the tire radial direction of the breaker layer so as to form a band-less structure in which the tread rubber is arranged so as to be directly in contact with the breaker layer in the tire radial direction, wherein the tread rubber includes a cap rubber layer forming the ground contacting surface of the tread portion, and a base rubber layer disposed inwardly in the tire radial direction of the cap rubber layer and having complex modulus greater than that of the cap rubber layer, the base rubber layer extends between a pair of outermost ends thereof so as to across the tire equator, and a thickness of the base rubber layer at the tire equator is greater than that of the outermost ends.

In another aspect of the disclosure, a thickness of the base rubber layer may decrease from the tire equator toward both outer sides in a tire axial direction.

In another aspect of the disclosure, a thickness of the base rubber layer may decrease continuously from the tire equator to the pair of outermost ends of the base rubber layer.

In another aspect of the disclosure, the base rubber layer may have loss tangent smaller than that of the cap rubber layer.

In another aspect of the disclosure, at the tire equator, a thickness of the base rubber layer may be in a range of 30% to 70% of a thickness of the tread rubber.

In another aspect of the disclosure, at the tire equator, a thickness of the base rubber layer may be in a range of 40% to 60% of a thickness of the tread rubber.

In another aspect of the disclosure, at positions 10 mm inward in a tire axial direction from respective tread edges, a thickness of the base rubber layer may be equal to or less than 30% of a thickness of the tread rubber.

In another aspect of the disclosure, at positions 10 mm inward in a tire axial direction from respective tread edges, a thickness of the base rubber layer may be in a range of 5% to 20% of a thickness of the tread rubber.

### BRIEF DESCRIPTION OF THE DRAWINGS

FIG. 1 is a cross-sectional view of an exemplary tire according to one or more embodiments.

### DESCRIPTION OF THE PREFERRED EMBODIMENTS

An embodiment of the present disclosure will be explained below with reference to the accompanying drawings.

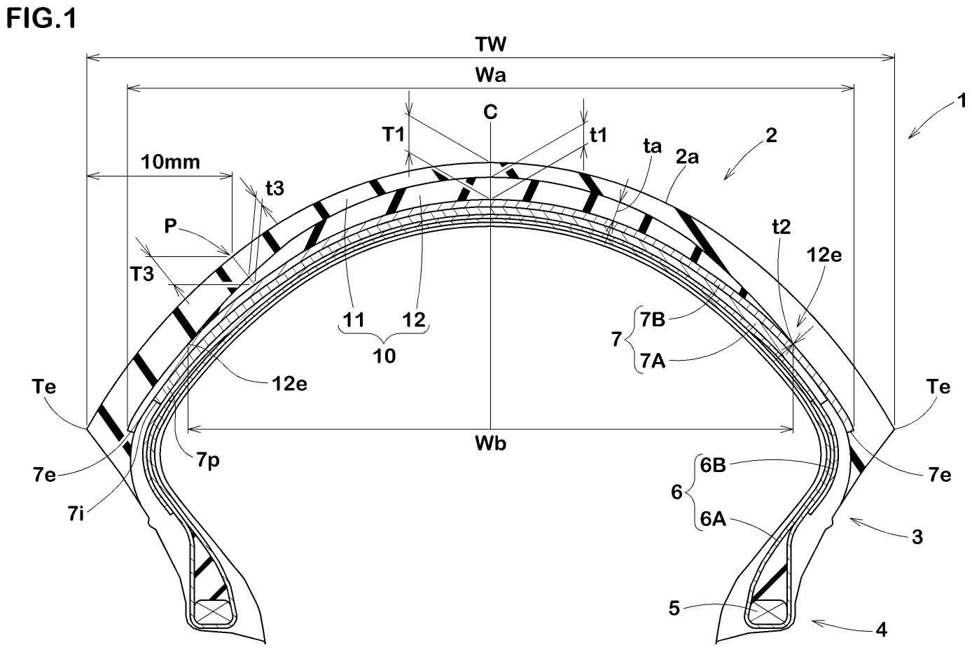

FIG. 1 is a cross-sectional view of an exemplary motorcycle tire 1 (hereinafter simply referred to as “tire”) under a normal state according to one or more embodiments. The tire 1 according to the present embodiment is suitably used for on-road driving such as on a dry asphalt road surface. However, the tire 1 according to the present invention is not limited to such an aspect of use.

As used herein, the “normal state” is such that the tire 1 is mounted onto a standard wheel rim (not illustrated) with a standard pressure but loaded with no tire load. Unless otherwise noted, dimensions of portions of the tire 1 are values measured under the normal state.

As used herein, the “standard wheel rim” is a wheel rim officially approved for each tire by standards organizations on which the tire 1 is based, wherein the standard wheel rim is the “standard rim” specified in JATMA, the “Design Rim” in TRA, and the “Measuring Rim” in ETRTO, for example.

As used herein, the “standard pressure” is a standard pressure officially approved for each tire by standards organizations on which the tire 1 is based, wherein the standard pressure is the “maximum air pressure” in JATMA, the maximum pressure given in the “Tire Load Limits at Various Cold Inflation Pressures” table in TRA, and the “Inflation Pressure” in ETRTO, for example.

As illustrated in FIG. 1, the tire 1 according to the present embodiment includes a tread portion 2 which is curved in an arc shape such that an outer surface of the tread portion 2 is convex outwardly in the tire radial direction in the tire cross-sectional view.

The tire according to the present embodiment further includes a carcass 6, a breaker layer 7 disposed outwardly in the tire radial direction of the carcass 6 in the tread portion 2, and a tread rubber 10 disposed outwardly in the tire radial direction of the breaker layer 7.

The carcass 6, for example, includes a first carcass ply 6A and a second carcass ply 6B disposed outwardly in the tire radial direction of the first carcass ply 6A. In the present embodiment, the first carcass ply 6A extends between axially spaced bead cores 5 disposed in bead portions 4. In the present embodiment, the second carcass ply 6B has both ends which terminate in sidewall portions 3 without reaching the bead cores 5. The carcass 6, for example, may employ a conventional structure.

In the present embodiment, the tread portion 2 has a band-less structure in which the tread rubber 10 is arranged so as to be directly in contact with the breaker layer 7 in the tire radial direction. In other words, the tread portion 2 according to the present embodiment is not provided with any band layers comprising one or more band plies having a cord oriented at an angle of less than 15 degrees with respect to the tire equator C. Such a tread portion 2 can improve ride comfort.

The breaker layer 7 includes one or more breaker plies 7p having a plurality of cords (not illustrated) oriented at an angle equal to or more than 15 degrees with respect to the tire equator C. In addition, the breaker layer 7 makes rigidity near the tire equator C smaller than rigidity on tread edges Te sides. As used herein, the “tread edges Te” are the outermost edges of the ground contact patch of the tread portion 2 in the tire axial direction.

In the present embodiment, the breaker layer 7 includes two layers of first and second breaker plies 7A and 7B that are superimposed in the tire radial direction. The first breaker ply 7A, in the present embodiment, has a development width as well as axial width smaller than that of the second breaker ply 7B. The both ends 7e in the tire axial direction of the second breaker ply 7B are located nearer the respective tread edges Te than the both ends 7i in the tire axial direction of the first breaker ply 7A. A distance Wa in the tire axial direction between the both ends 7e of the second breaker ply 7B is preferably equal to or more than 85% of the tread width TW, but preferably 95% or less of the tread width TW. Note that the tread width TW is a distance in the tire axial direction between the tread edges Te.

In the present embodiment, the tread rubber 10 includes a cap rubber layer 11 forming a ground contacting surface 2a of the tread portion 2, and a base rubber layer 12 disposed inwardly in the tire radial direction of the cap rubber layer 11. The base rubber layer 12 extends between a pair of outermost ends 12e thereof so as to across the tire equator C. The cap rubber layer 11, for example, extend across the tire equator C beyond the both outermost ends 12e of the base rubber layer 12 outwardly in the tire axial direction. The tread rubber 10, in the present embodiment, consists of the cap rubber layer 11 and the base rubber layer 12. That is, the cap rubber layer 11 according to the present embodiment is directly in contact with the base rubber layer 12.

The base rubber layer 12 has complex modulus E* greater than that of the cap rubber layer 11. In addition, a thickness t1 of the base rubber layer 12 at the tire equator C is greater than a thickness t2 of the outermost ends 12e. The base rubber layer 12 having a relatively large complex modulus E* increases rigidity of the tread portion 2 near the tire equator C, thus improving steering stability performance, especially transient property which is operability for leaning a vehicle body between straight running and turning, and braking performance. In addition, the cap rubber layer 11 having a relatively small complex elastic modulus E* generates a large amount of heat during running. Since the cap rubber layer 11 forms the ground contacting surface 2a, it increases the frictional force with the road surface and can improve steering stability performance, especially grip performance.

Preferably, a ratio E*2/E*1 of the complex modulus E*2 of the base rubber layer 12 to the complex modulus E*1 of the cap rubber layer 11 is in a range of 1.1 to 1.8. By setting the ratio E*2/E*1 being 1.1 to 1.8 and providing the difference in thickness t1 and t2 of the base rubber layer 12, the difference in rigidity of the tread portion 2 inside and outside in the tire axial direction becomes smaller. Thus, steering stability performance can further be improved. When the ratio E*2/E*1 is less than 1.1, the above-mentioned effect is less likely to be exerted. When the ratio E*2/E*1 exceeds 1.8, rigidity of the tread portion 2 on the tire equator C may be excessively large, and rigidity of the tread portion 2 on the tread edges Te side may become excessively small. In order to effectively exert the above-mentioned effect, the ratio E*2/E*1 is more preferably equal to or more than 1.2, but preferably equal to or less than 1.6. In addition, the complex modules E*2 of the base rubber layer 12 is preferably equal to or more than 3.0 MPa, more preferably equal to or more than 5.0 MPa, still further preferably equal to or more than 7.0 MPa, but preferably equal to or less than 20.0 MPa, more preferably equal to or less than 16.0 MPa, still further preferably equal to or less than 14.0 MPa.

A thickness ta of the base rubber layer 12 decreases from the tire equator C toward both outer sides in the tire axial direction. As a result, the difference in rigidity between the inside and outside of the tread portion 2 in the tire axial direction can be further reduced.

In order to exert the above-mentioned action more effectively, a thickness ta of the base rubber layer 12 preferably decreases continuously from the tire equator C to the pair of outermost ends 12e of the base rubber layer 12. In the present embodiment, the tread rubber 10, in the region axially outside the outermost ends 12e, is formed by only the cap rubber layer 11.

Preferably, at the tire equator C, a thickness t1 of the base rubber layer 12 is in a range of 30% to 70% of a thickness T1 of the tread rubber 10. By setting the thickness t1 being equal to or more than 30% of the thickness t1, rigidity of the tread portion 2 on or around the tire equator C can be improved. By setting the thickness t1 being equal to or less than 70% of the thickness T1, excessive increase of rigidity of the tread portion 2 on or around the tire equator C can be prevented. From this point of view, the thickness t1 is more preferably equal to or more than 40% of the thickness T1, but more preferably equal to or less than 60% of the thickness T1.

At positions P which is 10 mm inward in the tire axial direction from respective tread edges Te, a thickness t3 of the base rubber layer 12 is preferably equal to or less than 30% of a thickness T3 of the tread rubber 10. As a result, rigidity of the tread rubber 10 or the tread portion 2 is made uniform inside and outside in the tire axial direction so that steering stability of the tire can further be improved. From this point of view, the thickness t3 is more preferably equal to or more than 5% of the thickness T3, but more preferably equal to or less than 20% of the thickness T3.

Although not particularly limited, the thickness t3 of the base rubber layer 12 at the positions P is preferably equal to or more than 0.3 times the thickness t1 of the base rubber layer 12 at the tire equator C, more preferably equal to or more than 0.4 times, but preferably equal to or less than 0.8 times the thickness t1 of the base rubber layer 12 at the tire equator C, more preferably equal to or less than 0.7 times.

A width Wb in the tire axial direction between the outermost ends 12e of the base rubber layer 12 is not particularly limited. The width Wb is preferably equal to or more than 60% of the tread width TW, more preferably equal to or more than 65%, but preferably equal to or less than 80% of the tread width TW, more preferably equal to or less than 75%. The outermost ends 12e of the base rubber layer 12 are located closer to the tire equator C than outermost ends 7i in the tire axial direction of the first breaker ply 7A. The cap rubber layer 11, in this embodiment, forms tread edges Te.

The base rubber layer 12 has loss tangent tan δ2 smaller than loss tangent tan δ1 of the cap rubber layer 11. As a result, heat generation in the base rubber layer 12 may be suppressed, and durability of the tire can be improved. In addition, the cap rubber layer 11 having a relatively large loss tangent tan δ can exhibit excellent grip performance since the frictional force with the road surface is increased.

In order to exert the above-mentioned action more effectively, a ratio tan δ2/tan δ1 is preferably equal to or more than 0.5, more preferably equal to or more than 0.6, but preferably equal to or less than 0.9, more preferably equal to or less than 0.8. The ratio tan δ2/tan δ1 is a ratio of the loss tangent tan δ2 of the base rubber layer 12 to the loss tangent tan δ1 of the cap rubber layer 11. Further, the loss tangent tan δ2 of the base rubber layer 12 is preferably equal to or more than 0.10, more preferably equal to or more than 0.20, but preferably equal to or less than 0.40, more preferably equal to or less than 0.30.

As used herein loss tangent tan δ is the value measured under the following conditions according to the specification of JIS-K6394:

measuring device: viscoelastic spectrometer RSA (KABUSIKIKAISHA IWAMOTO SEISAKUSHO) initial strain 10%;
dynamic distortion: 1%;
frequency 10 Hz;
tensile deformation mode; and measured temperature 70 degrees C.

While some preferred embodiments of the present disclosure have been described in detail above, the present disclosure is not limited to the above-mentioned specific disclosure, but can be modified various aspects within the scope of the claims.

### EXAMPLE

Motorcycle tires having the basic structure shown in FIG. 1 were prototyped. Then, steering stability, braking performance, grip performance and durability of each prototype tire were tested. In the comparative example tire, the tread rubber is formed only by the cap rubber layer. The common specifications and test methods for each tire are as follows.

Cap Rubber Layer

E*1: 5.3 MPa, and

tan δ1: 0.25

### Steering Stability, Braking Performance and Braking Performance Test:

Each prototype tire was mounted on the front wheel of a motorcycle (displacement 1000 cc) under the following conditions. A commercially available tire was also mounted on the rear wheel under the following conditions. Then, a test rider rode the motorcycle on a dry asphalt road test course, and each performance was evaluated by the sensuality of the test rider. The test results are shown in Table 1 by the 10-point method with a maximum of 10 points. The larger the value, the better the performance is.

Prototype Tire Specification:

tire size: 120/70ZR17

rim size: 17×3.50 MT

internal pressure: 200 kPa

Rear Tire Specification:

tire size: 180/55R17

rim size: 17×5.50MT

internal pressure: 200 kPa

### Durability Test:

The condition of the tread rubber of each prototype tire was confirmed after the tires were run for 10,000 km. Those with peeling or cracking are failed, and those without peeling are passed.

Table 1 shows the test results.

TABLE 1

| | Ref. | Ex. 1 | Ex. 2 | Ex. 3 | Ex. 4 | Ex. 5 | Ex. 6 | Ex. 7 | Ex. 8 | Ex. 9 |
|---|---|---|---|---|---|---|---|---|---|---|
| Thickness of base rubber | — | t1 > t2 | t1 >t 2 | t1 > t2 | t1 > t2 | t1 > t2 | t1 > t2 | t1 > t2 | t1 > t2 | t1 > t2 |
| layer | | | | | | | | | | |
| Ratio (E*2/E*1) | — | 1.3 | 1.1 | 1.8 | 1.3 | 1.3 | 1.3 | 1.3 | 1.3 | 1.3 |
| Ratio t3/t1 | — | 0.6 | 0.6 | 0.6 | 0.3 | 0.8 | 0.6 | 0.6 | 0.6 | 0.6 |
| Ratio (tanδ/tanδ1) | — | 0.7 | 0.7 | 0.7 | 0.7 | 0.7 | 0.5 | 0.9 | 0.7 | 0.7 |
| Ratio t1/T1 (%) | — | 50 | 50 | 50 | 50 | 50 | 50 | 50 | 30 | 70 |
| Ratio t3/T3 (%) | — | 30 | 30 | 30 | 15 | 40 | 30 | 30 | 18 | 42 |
| Steering stability | 2.5 | 8.0 | 7.4 | 8.4 | 7.9 | 7.8 | 8.3 | 7.6 | 7.6 | 8.3 |
| [10-point method] | | | | | | | | | | |
| Braking performance | 2.0 | 8.5 | 8.0 | 8.5 | 8.1 | 8.6 | 8.4 | 7.9 | 7.9 | 8.4 |
| [10-point method] | | | | | | | | | | |
| Grip performance | 7.0 | 8.0 | 8.4 | 7.1 | 7.9 | 7.6 | 7.1 | 8.3 | 8.3 | 7.1 |
| [10-point method] | | | | | | | | | | |
| Total score [Larger is better.] | 11.5 | 24.5 | 23.8 | 24.0 | 23.9 | 24.0 | 23.8 | 23.8 | 23.8 | 23.8 |
| Durability [passed or failed] | failed | passed | passed | passed | passed | passed | passed | passed | passed | passed |

As a result of the test, it is confirmed that the tires of examples are superior in steering stability, braking performance, grip performance and durability compared to the comparative example tire.

What is claimed is:

1. A motorcycle tire comprising:
a tread portion having a ground contacting surface;
a carcass;
a breaker layer disposed outwardly in a tire radial direction of the carcass in the tread portion, the breaker layer comprising one or more breaker plies having a plurality of cords oriented at an angle equal to or more than 15 degrees with respect to a tire equator; and
a tread rubber disposed outwardly in the tire radial direction of the breaker layer so as to form a band-less structure in which the tread rubber is arranged so as to be directly in contact with the breaker layer in the tire radial direction, wherein
the tread rubber comprises
a cap rubber layer forming the ground contacting surface of the tread portion, and
a base rubber layer disposed inwardly in the tire radial direction of the cap rubber layer and having complex modulus greater than that of the cap rubber layer,
the base rubber layer extends between a pair of outermost ends thereof so as to across the tire equator, and
a thickness of the base rubber layer at the tire equator is greater than that of the outermost ends.

2. The motorcycle tire according to claim 1, wherein
a thickness of the base rubber layer decreases from the tire equator toward both outer sides in a tire axial direction.

3. The motorcycle tire according to claim 2, wherein
a thickness of the base rubber layer decreases continuously from the tire equator to the pair of outermost ends of the base rubber layer.

4. The motorcycle tire according to claim 1, wherein
the base rubber layer has loss tangent smaller than that of the cap rubber layer.

5. The motorcycle tire according to claim 1, wherein
at the tire equator, a thickness of the base rubber layer is in a range of 30% to 70% of a thickness of the tread rubber.

6. The motorcycle tire according to claim 1, wherein
at the tire equator, a thickness of the base rubber layer is in a range of 40% to 60% of a thickness of the tread rubber.

7. The motorcycle tire according to claim 1, wherein
at positions 10 mm inward in a tire axial direction from respective tread edges, a thickness of the base rubber layer is equal to or less than 30% of a thickness of the tread rubber.

8. The motorcycle tire according to claim 1, wherein
at positions 10 mm inward in a tire axial direction from respective tread edges, a thickness of the base rubber layer is in a range of 5% to 20% of a thickness of the tread rubber.

9. The motorcycle tire according to claim 1, wherein
the breaker layer comprises a first breaker ply and a second breaker ply disposed outwardly in the tire radial direction of the first breaker ply,
the first breaker ply has a width in a tire axial direction smaller than that of the second breaker ply, and
the base rubber layer has a width in the tire axial direction smaller than the width of the first breaker ply.

10. The motorcycle tire according to claim 1, wherein
a ratio E*2/E*1 of complex modulus E*2 of the base rubber layer to complex modulus E*1 of the cap rubber layer is in a range of 1.1 to 1.8.

11. The motorcycle tire according to claim 10, wherein
the complex modulus E*2 of the base rubber layer is in a range of 3.0 to 20.0 MPa.

12. The motorcycle tire according to claim 10, wherein
the complex modulus E*2 of the base rubber layer is in a range of 5.0 to 16.0 MPa.

13. The motorcycle tire according to claim 1, wherein
a thickness of the base rubber layer at positions 10 mm inward in a tire axial direction from respective tread edges is equal to or more than 0.3 times a thickness of the base rubber layer at the tire equator.

14. The motorcycle tire according to claim 13, wherein
a thickness of the base rubber layer at the positions 10 mm inward in the tire axial direction from the respective tread edges is equal to or less than 0.8 times a thickness of the base rubber layer at the tire equator.

15. The motorcycle tire according to claim 1, wherein
a width Wb in the tire axial direction between the outermost ends of the base rubber layer is in a range of 60% to 80% of a tread width TW.

16. The motorcycle tire according to claim 1, wherein
the base rubber layer has loss tangent tan δ2 smaller than loss tangent tan δ1 of the cap rubber layer.

17. The motorcycle tire according to claim 16, wherein
a ratio tan δ2/tan δ1 is in a range of 0.5 to 0.9.

18. The motorcycle tire according to claim 16, wherein
a ratio tan δ2/tan δ1 is in a range of 0.6 to 0.8.

19. The motorcycle tire according to claim 16, wherein
loss tangent tan δ2 of the base rubber layer is in a range of 0.10 to 0.40.

20. The motorcycle tire according to claim 16, wherein
loss tangent tan δ2 of the base rubber layer is in a range of 0.20 to 0.30.
